(19) United States
(12) Patent Application Publication
(10) Pub. No.: US 2017/0314661 A1
(43) Pub. Date: Nov. 2, 2017

(54) TAPER COMPENSATING HYDRODYNAMIC THRUST BEARINGS

(71) Applicants: Patrick LINDEMANN, Wooster, OH (US); Aditya DATTAWADKAR, Wooster, OH (US); Michael RESH, Massillon,, OH (US); Schaeffler Technologies AG & Co. KG, Herogenaurch (DE)

(72) Inventors: Patrick Lindemann, Wooster, OH (US); Aditya Dattawadkar, Wooster, OH (US); Michael Resh, Massillon, OH (US)

(73) Assignee: Schaeffler Technologies AG & Co. KG, Herzogenaurach (DE)

(21) Appl. No.: 15/526,067

(22) PCT Filed: Nov. 11, 2014
(86) PCT No.: PCT/US2014/064976

§ 371 Date: May 11, 2017

(51) Int. Cl. F16H 41/28; F16C 17/04; F16H 45/02; F16H 41/24

(52) U.S. Cl. CPC F16H 41/28; F16C 17/04; F16H 2041/246; F16C 2240/40; F16C 2226/74; F16H 2045/0221; F16H 45/02

(57) ABSTRACT

A torque converter comprising: an axis of rotation; a stator including a side plate having a first radial surface; one of an impeller shell or a turbine shell having a second tapered surface facing the stator side plate first radial surface; a hydrodynamic thrust bearing disposed between the stator side plate and the one of an impeller shell or a turbine shell, and comprising: a thrust surface facing one of the first radial surface or the second tapered surface with a fluid pathway therebetween; a supporting surface opposite the thrust surface and facing the other of the first radial surface or the second tapered surface; and an opening concentric with the axis of rotation; and, a gap between the supporting surface and the other of the first radial surface or the second tapered surface such that the bearing thrust surface is alignable to be parallel with the one of the first radial surface or the second tapered surface.

### FIELD

The invention relates generally to torque converters and more specifically to hydrodynamic thrust bearings or washers between stators and impellers in torque converters that provide compensation for planar imperfections at impeller shell inner surfaces.

### BACKGROUND

U.S. Pat. No. 8,453,439, hereby incorporated by reference herein, discloses a torque converter including a washer for a thrust bearing.

Hydrodynamic bearings are known, as described in Bearing Design in Machinery: Engineering Tribology and Lubrication (2002). Hydrodynamic bearings are known to wear unevenly if mating surface is not planar, such as when used between a stator and an impeller.

### BRIEF SUMMARY

Example aspects broadly comprise a torque converter as provided. The torque converter comprises: an axis of rotation; a stator including a side plate having a first radial surface; one of an impeller shell or a turbine shell having a second tapered surface facing the stator side plate first radial surface; a hydrodynamic thrust bearing disposed between the stator side plate and the one of an impeller shell or a turbine shell, and comprising: a thrust surface facing one of the first radial surface or the second tapered surface with a fluid pathway therebetween; a supporting surface opposite the thrust surface and facing the other of the first radial surface or the second tapered surface; and an opening concentric with the axis of rotation; and, a gap between the supporting surface and the other of the first radial surface or the second tapered surface such that the bearing thrust surface is alignable to be parallel with the one of the first radial surface or the second tapered surface. In an example aspect, the gap is at least 0.1 mm and at most 1.0 mm. In an example aspect, the supporting surface includes at least one annular ridge extending therefrom. In an example aspect, the side plate first radial surface includes at least one annular groove for receiving the at least one annular ridge, and wherein the gap is disposed between the annular groove and the annular ridge. In an example aspect, the side plate further includes a connection means for attaching to the hydrodynamic thrust bearing. In an example aspect, the connection means includes at least one axial retention feature and at least one anti-rotation feature. In an example aspect, the hydrodynamic thrust bearing further includes a snap portion for connecting to the side plate connection means. In an example aspect, the thrust surface further comprises at least one channel extending radially from the inner diameter to the outer diameter. In an example aspect, the supporting surface is attached to the impeller shell via at least one rivet.

Other example aspects broadly comprise a torque converter comprising: an axis of rotation; a stator including a side plate having: a first radial surface at a first axial distance relative to a second radial surface, perpendicular to the axis of rotation; and, a first line colinear with the first radial surface; an impeller shell having: a tapered inner surface facing the stator side plate first radial surface; and, a second line colinear with the tapered inner surface and non-parallel to the first line; a hydrodynamic thrust bearing disposed between the stator side plate and the impeller shell, and comprising: a thrust surface facing the tapered inner surface with a fluid pathway therebetween; a third line colinear with the thrust surface; a supporting surface opposite the thrust surface at a second axial distance, greater than the first axial distance, relative to the side plate; and, an opening concentric with the axis of rotation; and, a gap, as defined by the second axial distance being greater than the first axial distance, for aligning the thrust surface such that the third line is parallel to the second line. In an example aspect, the gap is at least 0.1 mm and at most 1.0 mm. In an example aspect, the supporting surface includes at least one annular ridge extending therefrom. In an example aspect, the side plate first radial surface includes at least one annular groove for receiving the at least one annular ridge, and wherein the gap is disposed between the annular groove and the annular ridge. In an example aspect, the side plate further includes a connection means for attaching to the hydrodynamic thrust bearing. In an example aspect, the connection means includes at least one axial retention feature and at least one anti-rotation feature. In an example aspect, the hydrodynamic thrust bearing further includes a snap portion for connecting to the side plate connection means. In an example aspect, the first bearing surface further comprises at least one channel extending radially from the inner diameter to the outer diameter.

Other example aspects broadly comprise a torque converter comprising: an axis of rotation; a stator including a side plate having: a first radial surface, perpendicular to the axis of rotation; and, a first line colinear with the first radial surface; an impeller shell having: a second tapered surface facing the stator side plate first radial surface; a second line colinear with the tapered surface and non-parallel to the first line; a hydrodynamic thrust bearing disposed between the stator side plate and the impeller shell, and comprising: a thrust surface facing the first radial surface with a fluid pathway therebetween; a third line colinear with the thrust surface; a supporting surface opposite the thrust surface and facing the second tapered surface having: an outer portion; a rounded portion, radially inward relative to the outer portion, having a radius; and, an opening concentric with the axis of rotation; and, a gap between the supporting surface and the second tapered surface for pivoting the thrust surface such that the third line is parallel to the first line. In an example aspect, the supporting surface further includes a flattened portion. In an example aspect, the outer portion is attached to the second tapered surface via at least one rivet.

### BRIEF DESCRIPTION OF THE DRAWINGS

The nature and mode of operation of the present invention will now be more fully described in the following detailed description of the invention taken with the accompanying drawing figures, in which:

FIG. 1 illustrates a partial cross-sectional side view of a torque converter in accordance with an example aspect;

FIG. 2 shows an expanded view (corresponding to box ‘B’ of FIG. 1) of a partial cross-sectional side view of a torque converter in accordance with an example aspect;

FIGS. 3A-3C illustrate cross-sectional views of a hydrodynamic thrust bearing mounted on a side plate for use between an impeller and a stator in accordance with an example aspect;

FIGS. 4A-4B illustrate partial cross-sectional side views of an alternative embodiment in accordance with an example aspect;

FIG. 5 illustrates an alternative embodiment in accordance with an example aspect;

FIGS. 6A-6B illustrate an alternative embodiment in accordance with an example aspect;

FIG. 7 illustrates a partial cross-sectional side view of a torque converter in accordance with an example aspect including a hydrodynamic thrust bearing compensating for taper of turbine shell; and,

FIG. 8 shows an expanded view (corresponding to box ‘C’ of FIG. 7) of a partial cross-sectional side view of a torque converter in accordance with an example aspect.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

The present disclosure provides a hydrodynamic thrust bearing including a compensation means for a thrust surface to be alignable with a mating surface, for example, the surface facing the thrust surface and separated by a fluid pathway, such as an inner surface of an impeller shell or a side plate radial surface or other surface as one skilled in the art would readily appreciate. Herein, the term ‘hydrodynamic thrust bearing’ may also be referred to interchangeably as ‘hydrodynamic bearing’, ‘thrust bearing’, ‘thrust washer’, or simply as ‘bearing’ or ‘washer’. For the purposes herein, as those skilled in the art recognize, impeller surfaces may be tapered due to brazing and/or welding sag or due to ballooning, hence, impeller inner surfaces are not sufficiently flat, even, or planar. In other words, impeller inner surfaces are tapered and thus not perfectly perpendicular to the axis of rotation. This causes uneven loading, for example, on an inner diameter or an outer diameter of a thrust washer depending upon the taper profile, and results in high wear, and thus shortened life, on the bearing.

In an example aspect, the design of the hydrodynamic thrust bearing and supporting surface is tailored to allow the bearing thrust surface to conform with the corresponding mating surface for even bearing wear. This is accomplished by moving, flexing, and/or pivoting the bearing to compensate for impeller taper. As one skilled in the art appreciates, the bearing disclosed may be integrated into or otherwise affixed to a side plate supporting a stator or, alternatively, may be attached to the impeller inner surface. In an example aspect, a gap is provided between the bearing and the surface to which it is attached to allow movement or flex of the bearing inner diameter and/or outer diameter. In an example aspect, the bearing is attached to the side plate using snap features integrated into the bearing or by other methods for attachment as known by those skilled in the art. Alternatively, in another example aspect, the bearing is attached to the impeller using attachment means such as an extruded rivet. Without being bound by theory, it is believed that the generation of a pressure wave in the hydrodynamic bearing disclosed herein includes fluid adhering to the bearing surface, which is dragged into a thin converging wedge by high shear forces, and then high pressure builds up in the fluid film to allow fluid to escape through the thin clearance between the bearing thrust surface and the mating surface. The bearing advantageously maintains at least one hydrodynamic pressure region on the bearing surface that prevents the bearing surface from coming into contact with the mating surface, for example, either the impeller inner surface in an example aspect or the side plate in another example aspect.

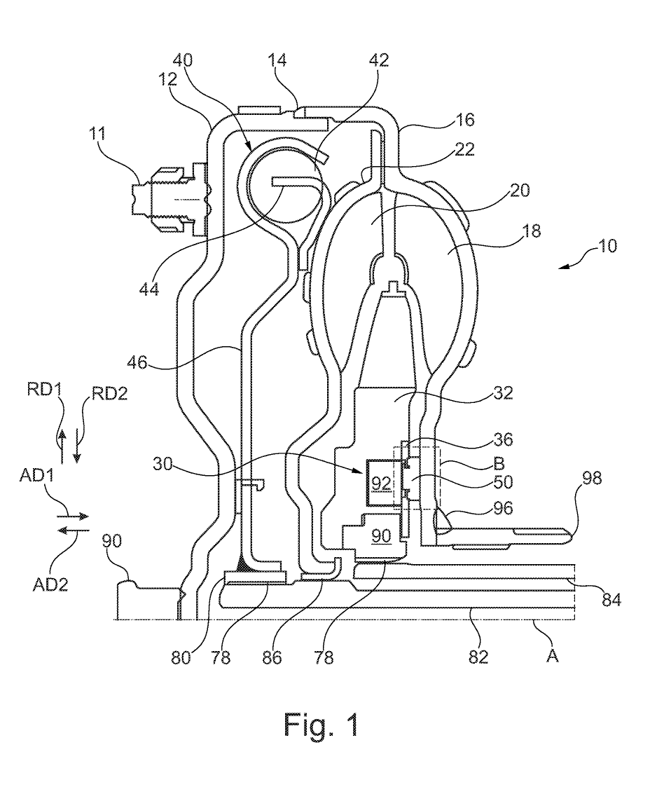

The following description is made with reference to FIGS. 1-8. Without being bound by theory, it is believed that the hydrodynamic thrust bearing disclosed herein positions itself parallel relative to the mating surface. The hydrodynamic thrust bearing may be formed by known methods in the art, and in an example aspect, is advantageously and economically formed by stamping. In an example aspect, sufficient flatness of the bearing is achieved in the stamping process and, therefore, surface machining may be eliminated.

FIG. 1 illustrates a partial cross sectional side view of a torque converter including a hydrodynamic thrust bearing according to an example aspect. Torque converter 10 includes front cover 12 for connecting to a crankshaft of an internal combustion engine via stud 11 and rear cover 16, also referred to as impeller shell interchangeably herein, for an impeller 18. Impellers are also referred to in the art interchangeably as ‘pump’. Front cover 12 and rear cover 16 are fastened together via weld 14. Cover 12 is fixed to cover pilot 90. Torque converter 10 also includes turbine 20, turbine shell 22, stator 32 between turbine 20 and impeller 18. Turbines and impellers, as is known in the art, include a plurality of blades.

Torque converter 10 includes one-way clutch 30, which supports stator 32, and includes inner race 90 and rocker 92, for example. Alternatively, one-way clutch 30 may comprise an inner race, a roller, and an outer race as is known in the art. Side plate 36 holds one-way clutch 30 in place within stator 32. Torque converter 10 also includes damper assembly 40, which is connected to and drivable by turbine 20, and is positioned between turbine 20 and front cover 12. Damper assembly 40 includes spring 42, flange 46, and drive tab 44 fixed to turbine shell 22.

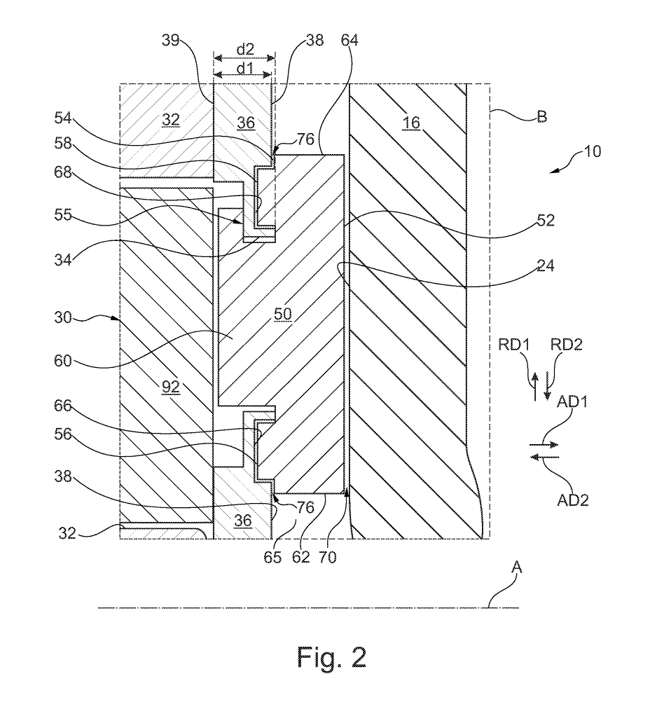

Torque converter 10 includes hydrodynamic thrust bearing 50 as will be described in greater detail in FIGS. 2-6. Torque converter 10, as shown in FIG. 1, further includes hub 80 fixed to flange 46, bushing 86, weld 96, and hub 98. FIG. 1 also shows transmission components splines 78, input shaft 82, and stator shaft 84. Hub 80 is splined to input shaft 82 and inner race 90 is splined to stator shaft 84 at splines 78. Bushing 86 positions and at least partially seals turbine shell 22 on shaft 82. Torque converter 10 includes axis of rotation A, also simply referred to as axis A. The portion of torque converter 10 noted by dashed outline of box ‘B’ is expanded in FIG. 2.

FIG. 2 shows an expanded view of a partial cross-sectional side view of torque converter 10, corresponding to box B of FIG. 1, having axis of rotation A. In an example aspect, torque converter 10 includes stator 32, one-way clutch 30 including rocker 92, side plate 36, hydrodynamic thrust bearing 50, gap 76 (between side plate 36 and hydrodynamic bearing 50), and impeller shell 16. Stator 32 includes side plate 36 having first radial surface 38 at first axial distance d1 relative to second radial surface 39. Radial surface 38 is substantially perpendicular to axis of rotation A. Impeller shell 16 includes tapered surface 24 facing the stator side plate first radial surface 38. Tapered surface 24 may also be interchangeably referred to as impeller inner surface 24. Hydrodynamic thrust bearing 50 is disposed between stator side plate 36 and impeller shell 16 and, in an example aspect, is fixed to side plate 36 by a snap fit arrangement or other methods as known in the art. Hydrodynamic bearing 50 is made of torlon, plastic, or other suitable material, for example, with ample flexibility to accommodate the snap fit means.

Hydrodynamic thrust bearing 50 comprises bearing surface 52, also referred to as thrust surface, first bearing surface, or the surface of hydrodynamic high pressure. Thrust surface 52 faces one of side plate radial surface 38 or impeller shell tapered surface 24 with fluid pathway 70 therebetween. Fluid or lubricant flow through torque converter 10 is fed through tight clearance or fluid pathway 70 between bearing surface 52 of hydrodynamic thrust bearing 50 and inner surface 24 of impeller shell 16 in an example aspect as shown in FIG. 2. Impeller shell inner surface 24 may be tapered or, in other words, off from perpendicular or non-perpendicular relative to axis A. Hydrodynamic thrust bearing 50 further comprises supporting surface 54, also referred to as opposite or second bearing surface 54, opposite thrust surface 52 and facing the other of side plate radial surface 38 or impeller shell tapered surface 24. Supporting surface 54 is at second axial distance d2 relative to second side plate radial surface 39. Gap 76 is generally characterized as the void space defined by the difference between distance d2 and d1, in other words, gap 76 equals about d2 minus d1. The gap clearance may fluctuate due to taper of shell 16 as one skilled in the art would appreciate. Thrust bearing 50 includes inner diameter 62, outer diameter 64, and opening 65 concentric with axis of rotation A. Bearing 50 further comprises gap 76 between supporting surface 54 and the other of first radial surface 38 or second tapered surface 24 such that bearing thrust surface 52 is alignable to be parallel with one of first radial surface 38 or second tapered surface 24. Gap 76, wherein second axial distance d2 being greater than first axial distance d1, is for aligning the thrust surface.

In an example aspect, gap 76 is at least 0.1 mm and at most 1.0 mm. In another example aspect, gap 76 is at least 0.2 mm and at most 0.8 mm. In yet another example aspect, gap 76 is at least 0.4 mm and at most 0.6 mm. In an example aspect, gap 76 is about 0.5 mm.

In an example aspect, bearing supporting surface 54 includes at least one annular ridge (56, 58) extending therefrom in axial direction AD2 toward side plate 36. In an example aspect, bearing supporting surface 54 includes first and second annular ridges wherein second annular ridge 58 is radially outward relative to first annular ridge 56. In an example aspect, side plate first radial surface 38 includes at least one annular groove (66, 68) for receiving the at least one annular ridge (56, 58), wherein gap 76 is disposed between annular groove (66, 88) and annular ridge (56, 58).

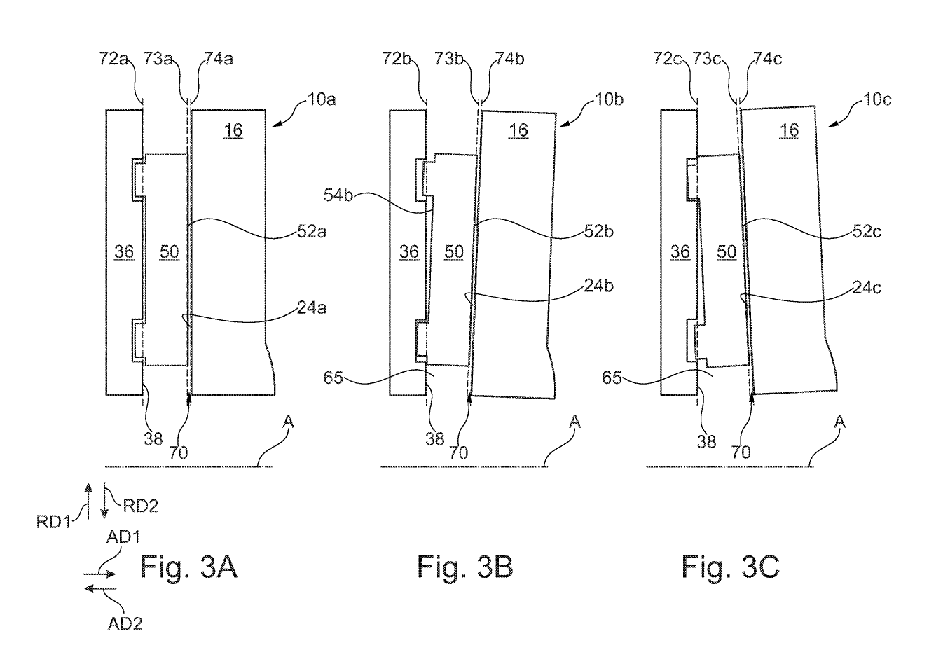

In an example aspect, side plate 36 further includes connection means 55 for attaching to hydrodynamic thrust bearing 50. Snap fit portion 60 of bearing 50 extends in axial direction AD2 and is configured to snap fit within side plate 36 as is known in the art. Connection means 55 includes at least one axial retention feature 34 and at least one anti-rotation feature as known in the art. Hydrodynamic thrust bearing includes snap fit portion 60 for connecting to side plate connection means 55. Connection means 55 need not be limited to being centered between inner diameter 62 and outer diameter 64 of bearing 50 and may alternatively extend from the bearing in other arrangements provided they do not interfere with annular ridges 56 or 58. Gaps 76 define the space between ridges (56, 58) and grooves (66, 68). Gaps 76 enable flex and movement of bearing 50 to conform to shape or taper of mating surface, in the example of FIG. 2, of impeller shell inner surface 24. FIG. 3 illustrates said flex/movement schematically.

FIGS. 3A-3C exaggerate taper to better illustrate bearing movement to compensate for impeller inner surface taper. FIG. 3A shows torque converter 10a comprising: axis of rotation A, first line 72a colinear with radial surface 38, second line 73a colinear with inner surface 24a, and third line 74a colinear with thrust surface 52a. In the example as shown in FIG. 3A, all three lines 72a, 73a, and 74a are substantially perpendicular to axis A and therefore substantially parallel to one another; hence, the thrust bearing need not move or provide compensation in this instance.

FIGS. 3B and 3C illustrate example aspects whereby compensation to tapered impeller shell surfaces is needed and achieved. FIG. 3B illustrates an example aspect wherein the impeller shell inner surface is tapered in axial direction AD1 as moving outwardly in radial direction RD1. Torque converter 10b includes stator 32 having side plate 36, wherein side plate 36 includes first radial surface 38, perpendicular to axis of rotation A and first line 72b colinear with radial surface 38. Impeller shell 16 has tapered inner surface 24b facing stator side plate first radial surface 38 and a second line 73b colinear with tapered inner surface 24b and non-parallel to first line 72b. Hydrodynamic thrust bearing 50 is disposed between stator side plate 36 and impeller shell 16 and comprises thrust surface 52b facing tapered inner surface 24b with fluid pathway 70 therebetween, third line 74b colinear with thrust surface 52b, supporting surface 54b opposite thrust surface 52b, opening 65 concentric with axis of rotation A, and gap 76, as defined by second axial distance d2 being greater than the first axial distance d1 (refer to FIG. 2), for aligning thrust surface 52b such that third line 74b is parallel to second line 73b.

FIG. 3C illustrates an example aspect wherein the impeller shell inner surface is tapered in axial direction AD1 as moving inwardly in radial direction RD2. Torque converter 10c includes stator 32 having side plate 36, wherein side plate 36 includes first radial surface 38, perpendicular to axis of rotation A and first line 72c colinear with radial surface 38. Impeller shell 16 has tapered inner surface 24c facing stator side plate first radial surface 38 and a second line 73c colinear with tapered inner surface 24c and non-parallel to first line 72c. Hydrodynamic thrust bearing 50 is disposed between stator side plate 36 and impeller shell 16 and comprises thrust surface 52c facing tapered inner surface 24c with fluid pathway 70 therebetween, third line 74c colinear with thrust surface 52c, supporting surface 54c opposite thrust surface 52c, opening 65 concentric with axis of rotation A, and gap 76, as defined by second axial distance d2 being greater than the first axial distance d1 (refer to FIG. 2), for aligning thrust surface 52c such that third line 74c is parallel to second line 73c.

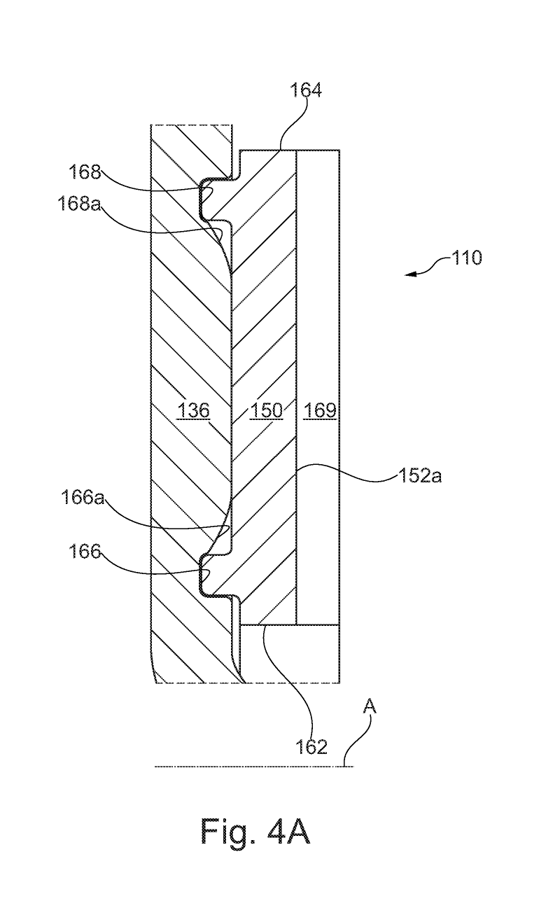

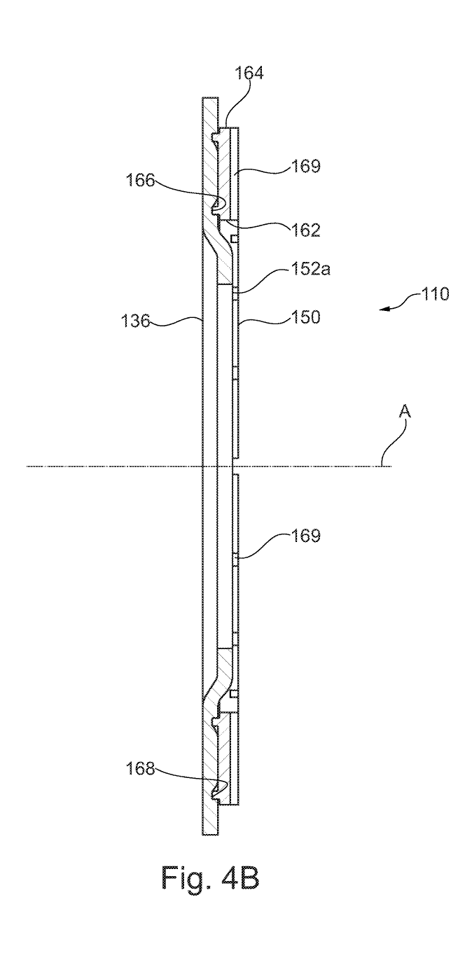

The shape and number of annular grooves and annular ridges are not limited herein, and as those skilled in the art would readily appreciate, the grooves and ridges may vary in number, size, and shape accordingly. In an example aspect, the ridges are fulcrum, rounded, or conical in shape, and are in keeping with shapes suitable to accommodate a gap spaced between said annular grooves and annular ridges. FIGS. 4a-4b show, in an example aspect, a partial cross-sectional side view of torque converter 110 wherein grooves 166, 168 of side plate 136 are tapered. In an example aspect, as in FIG. 4A, tapered section 166a is radially outward relative to groove 166, while tapered section 168a is radially inward relative to groove 168. Tapered sections 166a, 168a of grooves 166, 168 provide radius and are believed to aid in manufacturability and ease of operation. In an example aspect, thrust surface 152 comprises at least one channel 169 extending radially from inner diameter 162 to outer diameter 164. In an example aspect, as shown in FIG. 4B, a plurality of radial channels 169 are evenly spaced on thrust surface 152 to channel bottom surface 152a of bearing 150.

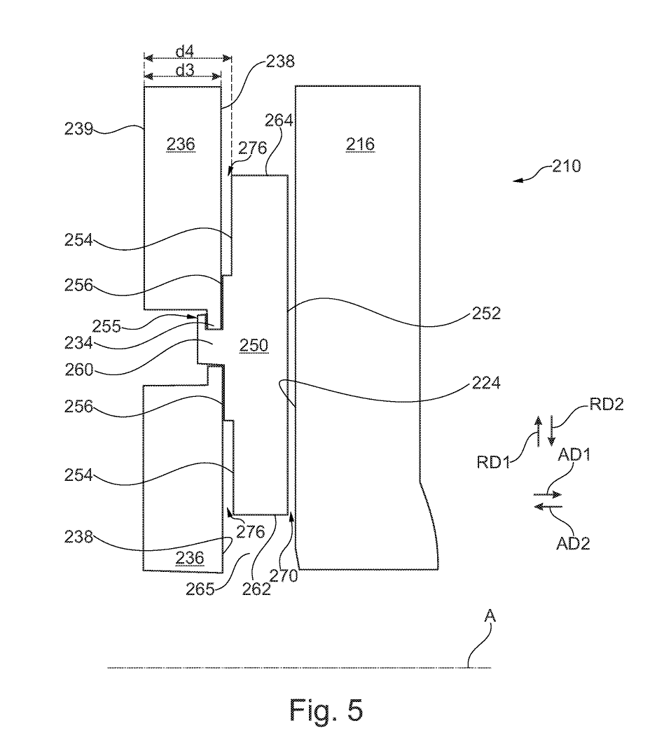

In another example aspect, FIG. 5 shows a hydrodynamic thrust bearing having a step configuration for torque converter 210. Hydrodynamic thrust bearing 250 comprises bearing surface 252, also referred to as thrust surface, first bearing surface, or the surface of hydrodynamic high pressure. Thrust surface 252 faces impeller shell tapered surface 224 with fluid pathway 270 therebetween. Impeller shell inner surface 224 may be tapered or, in other words, off from perpendicular or non-perpendicular relative to axis A. Hydrodynamic thrust bearing 250 further comprises supporting surface 254, also referred to as opposite or second bearing surface 254, opposite thrust surface 252 and facing side plate radial surface 238. Supporting surface 254 is at fourth axial distance d4 relative to second side plate radial surface 239. Thrust bearing 250 includes inner diameter 262, outer diameter 264, and opening 265 concentric with axis of rotation A. Bearing surface 252 further comprises channels extending radially from the inner diameter to the outer diameter, similarly as shown in FIG. 4. Bearing 250 further comprises gap 276 between supporting surface 54 and first radial surface 238 such that bearing thrust surface 252 is alignable to be parallel with tapered surface 224. Gap 276, as defined by fourth axial distance d4 being greater than third axial distance d3, is for aligning the thrust surface.

In an example aspect, gap 276 is at least 0.1 mm and at most 1.0 mm. In another example aspect, gap 276 is at least 0.2 mm and at most 0.8 mm. In yet another example aspect, gap 276 is at least 0.4 mm and at most 0.6 mm. In an example aspect, gap 276 is about 0.5 mm.

In an example aspect, supporting surface 254 includes at least one annular ridge or step 256 extending therefrom in axial direction AD2 toward side plate 236. Hydrodynamic thrust bearing 250 includes snap fit portion 260 for connecting to side plate connection means 255. In an example aspect, bearing supporting surface 254 includes first and second annular steps concentric about connection means 255 for attaching hydrodynamic thrust bearing 250 to side plate 236. Snap fit portion 260 of bearing 250 extends in axial direction AD2 and is configured to snap fit within side plate 236 as is known in the art. Connection means 255 includes at least one axial retention feature 234 and at least one anti-rotation feature as known in the art. Gaps 276 define the space between bearing supporting surface 254 and side plate radial surface 238. Gaps 276 enable flex and movement of bearing 250 to conform to shape or taper of mating surface, in the example of FIG. 5, of impeller shell inner surface 224.

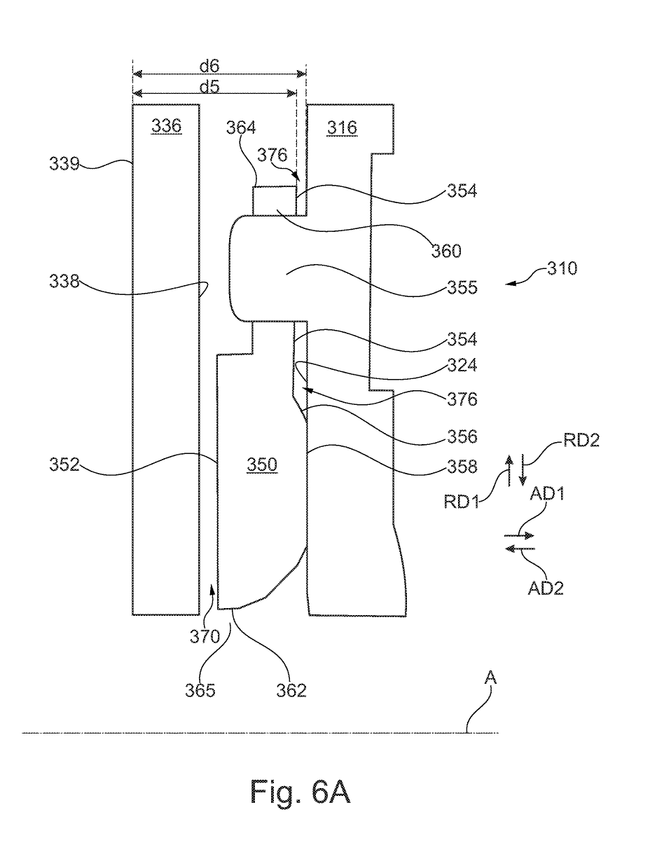

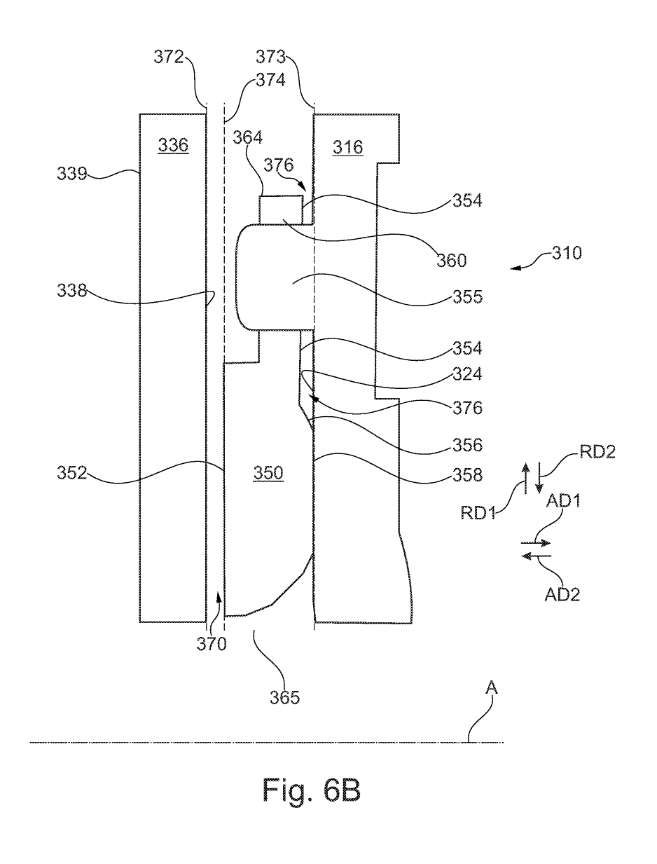

In another example aspect, FIG. 6A shows a hydrodynamic thrust bearing having a supporting surface with a radius for torque converter 310. Hydrodynamic thrust bearing 350 comprises bearing surface 352, also referred to as thrust surface, first bearing surface, or the surface of hydrodynamic high pressure. Thrust surface 352 faces side plate radial surface 338 with fluid pathway 370 therebetween. Impeller shell inner surface 324 may be tapered or, in other words, off from perpendicular or non-perpendicular relative to axis A. Hydrodynamic thrust bearing 350 further comprises supporting surface 354, also referred to as opposite or second bearing surface 354, opposite thrust surface 352 and facing impeller shell inner surface 324. Supporting surface 354 is at fifth axial distance d5 relative to second side plate radial surface 339. Thrust bearing 350 includes inner diameter 362, outer diameter 364, and opening 365 concentric with axis of rotation A. Bearing surface 352 further comprises channels extending radially from the inner diameter to the outer diameter, similarly as shown in FIG. 4. Bearing 350 further comprises gap 376 between supporting surface 354 and impeller shell inner surface 324 such that bearing thrust surface 352 is alignable to be parallel with tapered surface 324. Gap 376, as defined by sixth axial distance d6 being greater than fifth axial distance d5, is for aligning the thrust surface.

In an example aspect, gap 376 is at least 0.1 mm and at most 1.0 mm. In another example aspect, gap 376 is at least 0.2 mm and at most 0.8 mm. In yet another example aspect, gap 376 is at least 0.4 mm and at most 0.6 mm. In an example aspect, gap 376 is about 0.5 mm.

In an example aspect, bearing supporting surface 354 includes radius or rounded portion 356 extending therefrom in axial direction AD1 toward tapered surface 324. Radius portion 356 is rounded about a radius and further includes pivot surface or flattened portion 358. Supporting surface 354 is attached to the impeller shell via at least one rivet. Hydrodynamic thrust bearing 350 includes extended or outer portion 360 for connecting to extruded rivet 355 extending from impeller shell inner surface 324 in axial direction AD2. Extruded rivet 355 includes at least one axial retention feature and at least one anti-rotation feature as known in the art. Gap 376 defines the space between bearing supporting surface 354 and impeller shell inner surface 324. Gap 376 enables movement and/or pivot of bearing surface 352 of bearing 350 to conform to shape or taper of impeller shell inner surface 324, as shown in FIG. 6A.

In an example aspect, torque converter 310 comprises axis of rotation A and stator (element 32 as in FIG. 2) including side plate 336 having radial surface 338, perpendicular to axis of rotation A, and first line 372 colinear with radial surface 338. Torque converter 310 of FIG. 6B further comprises impeller shell 316 having tapered inner surface 324 (referred to also as tapered surface 324) facing stator side plate first radial surface 338, second line 373 colinear with tapered inner surface 324 and non-parallel to first line 372. Torque converter 310 further comprises hydrodynamic thrust bearing 350, disposed between stator side plate 336 and impeller shell 316, and comprising: thrust surface 352 facing radial surface 338 with fluid pathway 370 therebetween, third line 374 colinear with thrust surface 352, and supporting surface 354 opposite thrust surface 352 and facing the tapered inner surface 324. Supporting surface 354 comprises outer portion 360, rounded portion 356 radially inward relative to outer portion 360 and having a radius, and opening 365 concentric with the axis of rotation. Hydrodrynamic thrust bearing 350 further comprises gap 376 disposed between supporting surface 354 and tapered surface 324 for pivoting thrust surface 352 such that third line 374 is parallel to first line 372. In an example aspect, supporting surface 354 further includes flattened portion 358. In an example aspect, outer portion 360 is attached to tapered surface 324 via at least one rivet 355. In an example aspect, the rivet is an extruded rivet.

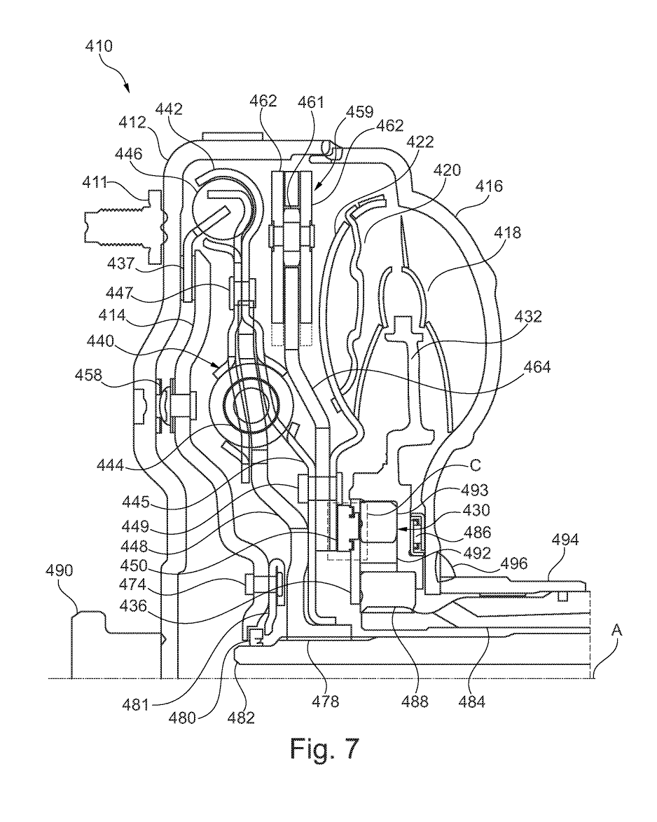

In yet another example aspect, the hydrodynamic thrust bearing is useful for compensation for taper as is known for a turbine shell. FIG. 7 illustrates a cross sectional side view of a torque converter including a hydrodynamic thrust bearing according to an example aspect. Torque converter 410 includes front cover 412 for connecting to a crankshaft of an internal combustion engine via stud 411 and rear cover 416, also referred to as impeller shell interchangeably herein, for an impeller 418. Torque converter 410 also includes turbine 420, turbine shell 422, stator 432 between turbine 420 and impeller 418, and one-way clutch 430 supporting stator 432. Side plate 436 holds one-way clutch 430 in place within stator 432. One-way clutch 430 comprises an inner race, a roller, and an outer race as is known in the art. Torque converter 410 includes axis of rotation A.

Torque converter 410 includes piston 414, clutch plate 437, and leaf springs 458. Leaf springs 458 connect front cover 412 and piston 414. Torque converter 410 further includes damper assembly 440 including spring retainer 442, springs 444, radially outward springs 446, flange 448, rivets 447, 449, and cover plate 445. Damper assembly 440 is connected to and drivable by turbine 420, and is positioned between turbine 420 and front cover 412. Torque converter 410 further includes pendulum assembly 459 including pendulum weights 462 connected by connecting element 461 and pendulum flange 464.

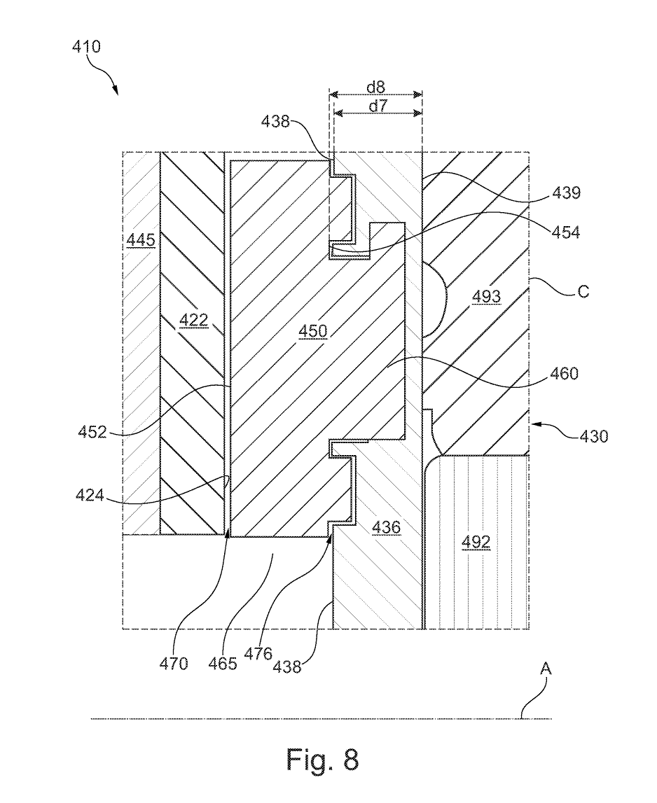

Torque converter 410 includes hydrodynamic thrust bearing 450 as shown in greater detail in FIG. 8. Torque converter 410 further includes bearing 486, inner race 488, roller 492, and outer race 493 for one-way clutch 430, hub 494, and weld 496. Cover pilot 490 is shown in FIG. 7 as are transmission components spline 478, input shaft 482 and stator shaft 484. Seal 480 is engaged with shaft 482 and positioned between radially inward portions of piston 414 and folded seal retention plate 481. Seal retention plate 481 is fixed to piston 414 by rivet 474. Seal 480, which is a dynamic seal, is a teflon seal in an example aspect; alternatively, seal 480 is an o-ring. Torque converter 410 includes axis of rotation A, also simply referred to as axis A. The portion of torque converter 410 including bearing 450 noted by dashed outline of box ‘C’ is expanded in FIG. 8.

FIG. 8 illustrates an expanded view of a partial cross-sectional side view of torque converter 410, corresponding to box C of FIG. 7, having axis of rotation A. In an example aspect, torque converter 410 includes one-way clutch 430 including outer race 493 and roller 492, side plate 436, hydrodynamic thrust bearing 450, gap 476 (between side plate 436 and hydrodynamic bearing 450), and turbine shell 422 fixed to cover plate 445. Side plate 436 includes first radial surface 438 at first axial distance d7 relative to second radial surface 439. Radial surface 438 is substantially perpendicular to axis of rotation A. Turbine shell 422 includes tapered surface 424 facing the stator side plate first radial surface 438. It is noted that the taper is not exaggerated as illustrated for examples in FIGS. 3A-3C, and those skilled in the art would recognize, tapered surface 424 includes slight taper. In other words and in an example aspect, surface 424 is not exactly perpendicular to axis A prior to taper compensation. Tapered surface 424 may also be interchangeably referred to as turbine shell inner surface 424. Hydrodynamic thrust bearing 450 is disposed between stator side plate 436 and turbine shell 422 and, in an example aspect, is fixed to side plate 436 by a snap fit arrangement by snap fit means 460 or other methods as known in the art. Hydrodynamic bearing 450 is made of torlon, plastic, or other suitable material, for example, with ample flexibility to accommodate the snap fit means.

Hydrodynamic thrust bearing 450 comprises bearing surface 452, also referred to as thrust surface, first bearing surface, or the surface of hydrodynamic high pressure. Thrust surface 452 faces turbine shell tapered surface 424 with fluid pathway 470 therebetween. Fluid or lubricant flow through torque converter 410 is fed through tight clearance or fluid pathway 470 between bearing surface 452 of hydrodynamic thrust bearing 450 and inner surface 424 of turbine shell 422 in an example aspect as shown in FIG. 8. Turbine shell inner surface 424 may be tapered or, in other words, off from perpendicular or non-perpendicular relative to axis A. Hydrodynamic thrust bearing 450 further comprises supporting surface 454, also referred to as opposite or second bearing surface 454, opposite thrust surface 452 and side plate radial surface 438. Supporting surface 454 is at second axial distance d8 relative to second side plate radial surface 439. Gap 476 is generally characterized as the void space defined by the difference between distance d8 and d7, in other words, gap 476 equals about d8 minus d7. The gap clearance may fluctuate due to taper of shell 422 as one skilled in the art would appreciate. Thrust bearing 450 includes opening 465 concentric with axis of rotation A. Bearing 450 further comprises gap 476 between supporting surface 454 and first radial surface 438 such that bearing thrust surface 452 is alignable to be parallel with second tapered surface 424. Gap 476, wherein second axial distance d8 is greater than first axial distance d7, is for aligning the thrust surface.

In an example aspect, gap 476 is at least 0.1 mm and at most 1.0 mm. In another example aspect, gap 476 is at least 0.2 mm and at most 0.8 mm. In yet another example aspect, gap 476 is at least 0.4 mm and at most 0.6 mm. In an example aspect, gap 476 is about 0.5 mm. In yet another example aspect, taper compensating hydrodynamic thrust bearings may be used independently both adjacent to the impeller shell and adjacent to the turbine shell.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

1-10. (canceled)

11. A torque converter comprising:
an axis of rotation;
a stator including a side plate having a radial surface;
one of an impeller shell or a turbine shell having a tapered surface facing the radial surface of the side plate;
a hydrodynamic thrust bearing disposed between the side plate of the stator and one of the impeller shell or the turbine shell, and comprising:
a thrust surface facing one of the radial surface or the tapered surface with a fluid pathway therebetween;
a supporting surface opposite the thrust surface and facing the other of the radial surface or the tapered surface; and
an opening concentric with the axis of rotation; and
a gap between the supporting surface and the other of the radial surface or the tapered surface such that the thrust surface of the hydrodynamic thrust bearing is alignable to be parallel with one of the radial surface or the tapered surface.

12. The torque converter of claim 11, wherein the gap is at least 0.1 mm and at most 1.0 mm.

13. The torque converter of claim 11, wherein the supporting surface includes an annular ridge extending therefrom.

14. The torque converter of claim 13, wherein the radial surface of the side plate includes an annular groove for receiving the annular ridge, and wherein the gap is disposed between the annular groove and the annular ridge.

15. The torque converter of claim 11, wherein the side plate further includes a connection means for attaching to the hydrodynamic thrust bearing.

16. The torque converter of claim 15, wherein the connection means includes an axial retention feature and an anti-rotation feature.

17. The torque converter of claim 15, wherein the hydrodynamic thrust bearing further includes a snap portion for connecting to the connection means of the side plate.

18. The torque converter of claim 11, wherein the thrust surface further comprises a channel extending radially from an inner diameter of the hydrodynamic thrust bearing to an outer diameter of the hydrodynamic thrust bearing.

19. The torque converter of claim 11, wherein the supporting surface is attached to the impeller shell via a rivet.

20. A torque converter comprising:
an axis of rotation;
a stator including a side plate having:
a first radial surface at a first axial distance relative to a second radial surface, perpendicular to the axis of rotation; and
a first line colinear with the first radial surface;
an impeller shell having:
a tapered inner surface facing the first radial surface of the side plate; and
a second line colinear with the tapered inner surface and non-parallel to the first line;
a hydrodynamic thrust bearing disposed between the side plate and the impeller shell, and comprising:
a thrust surface facing the tapered inner surface with a fluid pathway therebetween;
a third line colinear with the thrust surface;
a supporting surface opposite the thrust surface at a second axial distance, greater than the first axial distance, relative to the side plate; and
an opening concentric with the axis of rotation; and
a gap, as defined by the second axial distance being greater than the first axial distance, for aligning the thrust surface such that the third line is parallel to the second line.

21. The torque converter of claim 20, wherein the gap is at least 0.1 mm and at most 1.0 mm.

22. The torque converter of claim 20, wherein the supporting surface includes an annular ridge extending therefrom.

23. The torque converter of claim 22, wherein the first radial surface of the side plate includes an annular groove for receiving the annular ridge, and wherein the gap is disposed between the annular groove and the annular ridge.

24. The torque converter of claim 20, wherein the side plate further includes a connection means for attaching to the hydrodynamic thrust bearing.

25. The torque converter of claim 24, wherein the connection means includes an axial retention feature and an anti-rotation feature.

26. The torque converter of claim 24, wherein the hydrodynamic thrust bearing further includes a snap portion for connecting to the connection means of the side plate.

27. The torque converter of claim 20, wherein the thrust surface further comprises a channel extending radially from an inner diameter of the hydrodynamic thrust bearing to an outer diameter of the hydrodynamic thrust bearing.

28. A torque converter comprising:
an axis of rotation;
a stator including a side plate having:
a first radial surface perpendicular to the axis of rotation; and
a first line colinear with the first radial surface;
an impeller shell having:
a tapered surface facing the first radial surface of the side plate;
a second line colinear with the tapered surface and non-parallel to the first line;
a hydrodynamic thrust bearing disposed between the side plate and the impeller shell, and comprising:
a thrust surface facing the first radial surface with a fluid pathway therebetween;
a third line colinear with the thrust surface;
a supporting surface opposite the thrust surface and facing the tapered surface having:
an outer portion;
a rounded portion, radially inward relative to the outer portion, having a radius; and
an opening concentric with the axis of rotation; and
a gap between the supporting surface and the tapered surface for pivoting the thrust surface such that the third line is parallel to the first line.

29. The torque converter of claim 28, wherein the supporting surface further includes a flattened portion.

30. The torque converter of claim 28, wherein the outer portion is attached to the tapered surface via a rivet.
